(19) United States
(12) Patent Application Publication
(10) Pub. No.: US 2015/0278036 A1
(43) Pub. Date: Oct. 1, 2015

(54) INFORMATION PROCESSING SYSTEM AND METHOD OF SAME

(71) Applicant: MITSUBISHI PRECISION CO., LTD, Tokyo (JP)

(72) Inventor: Junichi ABEKI, Kanagawa (JP)

(21) Appl. No.: 14/672,762

(22) Filed: Mar. 30, 2015

(30) Foreign Application Priority Data
Mar. 31, 2014 (JP) 2014072562

(51) Int. Cl. G06F 11/14

(52) U.S. Cl. CPC G06F 11/1474; G06F 2201/82; G06F 2201/85; G06F 2201/87

(57) ABSTRACT

An information processing system includes a controller, a terminal and a plurality of servers, and the controller attaches successive identification numbers to requests received from the terminal and transmits the requests to the plurality of servers and transmits one of responses received from the servers to the terminal, and each server receives, in the case where the identification number of this time and the identification number of the previous time are not successive numbers, the contents of a change (s) in resources associated with a missing identification number (a) from another server, and after changing the resources, performs predetermined processing in accordance with received request, creates a response, changes the resources, transmits the response to the controller, and stores the identification number of this time and the contents of the change in the resources associated with the identification number of this time.

### CROSS-REFERENCE TO RELATED APPLICATIONS

This application is based upon and claims the benefit of priority of the prior Japanese Patent Application No. 2014-072562, filed on Mar. 31, 2014, the entire contents of which are incorporated herein by reference.

### FIELD

The present invention relates to an information processing system and a method of the same.

### BACKGROUND

Conventionally, a system has been used, in which a server having resources performs predetermined processing in accordance with a request received from a client terminal and creates a response and at the same time, changes the resources in accordance with the contents of the processing and transmits the response to the client terminal.

In many of the systems such as those described above, the server is required to work continuously 24 hours a day and 365 days a year. If the server that is the core of the system fails, then the operation of the entire system stops.

Because of this, measures are taken so as to prevent the function of the system from being lost by switching a failed server to an alternative normal server, etc., in the case where a failure, has occurred in the server.

Specifically, it is common to make the system redundant by including a running server that performs actual processing and a standby server that stands by without performing actual processing. If the running server fails, the failed server is switched to the standby server so as to prevent the function of the system from being lost.

### SUMMARY

However, a period of time during which the system is not in operation occurs after an abnormality of the running server is detected until the failed running server is switched to the standby server because of the need to perform the switching procedure.

Further, if the standby server has an abnormality, there is a case where switching from the running server to the standby server cannot be performed.

Furthermore, there is a possibility that trouble will occur during the switching task because the task to switch the failed running server to the standby server is complicated.

In such circumstances, a fault-tolerant server that operates while maintaining real-time synchronization of hardware, such as duplexed processor and memory, has been proposed.

However, in the fault-tolerant server, the hardware is coupled firmly and there are many restrictions, and therefore, it is difficult to configure a system in which the servers are distributed at remote sites, and the fault-tolerant server is expensive.

Because of this, an object of the present specification is to provide an information processing system and a method thereof capable of solving the above-described problem, of being easily made redundant with three or more servers, and of arranging part of the servers at remote sites.

According to the information processing system that is disclosed in the present specification, the information processing system is a system in which a server having resources performs predetermined processing in accordance with a request received from a client terminal and creates a response and at the same time, changes the resources in correspondence to the contents of the processing and transmits the response to the client terminal. The system includes a controller connected with the client terminal(s) so as to be capable of performing communication and a plurality of servers connected with the controller so as to be capable of performing communication. The controller attaches successive identification numbers to the requests received from the client terminal, transmits the received requests to the plurality of servers, and transmits a response generated based on one of the responses received from the plurality of servers or a plurality of responses received from the plurality of servers to the client terminal having transmitted the requests. In the case where the identification number of this time attached to the received request and the identification number of the previous time attached to the request received the previous time are successive numbers, each of the servers performs predetermined processing in accordance with the received request and creates a response and at the same time, changes the resources in correspondence to the contents of the processing, transmits the response to the controller, and stores the identification number of this time and the contents of the change in the resources associated with the identification number of this time. In the case where the identification number of this time and the identification number of the previous time are not successive numbers, each of the servers receives the contents of the change in the resource associated with a missing identification number(s) located between the identification number of this time and the identification number of the previous time from another of the servers and after changing the resources by reflecting the contents of the change in the resources associated with the missing identification number(s) in the resources, performs predetermined processing in accordance with the received request, and creates a response and at the same time, changes the resources in correspondence to the contents of the processing, transmits the response to the controller, and stores the identification number of this time and the contents of the change in the resources associated with the identification number of this time.

According to the information processing method that is disclosed in the present specification, the information processing method is an information processing method in which a server having resources performs predetermined processing in accordance with a request received from a client terminal and creates a response and at the same time, changes the resources in correspondence to the contents of the processing and transmits the response to the client terminal. The method includes a step of, by a controller connected with the client terminal (a) so as to be capable of performing communication, attaching successive identification numbers to the requests received from the client terminal and transmitting the received requests to the plurality of servers, a step of, by each of the servers, in the case where the identification number of this time attached to the received request and the identification number of the previous time attached to the request received the previous time are successive numbers, performing predetermined processing in accordance with the received request, creating a response and at the same time, changing the resources in correspondence to the contents of the processing, transmitting the response to the controller, and storing the identification number of this time and the contents of the change in the resources associated with the identification number of this time, a step of, by each of the servers, in the case where the identification number of this time and the identification number of the previous time are not successive numbers, receiving the contents of the change in the resource associated with a missing identification number(s) located between the identification number of this time and the identification number of the previous time from another of the servers and after changing the resource by reflecting the contents of the change in the resources associated with the missing identification number(s) in the resources, performing predetermined processing in accordance with the received request and creating a response and at the same time, changing the resources in correspondence to the contents of the processing, transmitting the response to the controller, and storing the identification number of this time and the contents of the change in the resources associated with the identification number of this time, and a step of, by the controller, transmitting a response generated based on one of the responses received from the plurality of servers or a plurality of responses received from the plurality of servers to the client terminal having transmitted the request.

According to the information processing system that is disclosed in the present specification, the information processing system is an information processing system an which a server having resources performs predetermined processing in accordance with a request received from a client terminal, changes the resource in correspondence to the contents of the processing, and transmits the result (s) of the processing of one or a plurality of requests to the client terminal. The information processing system includes a plurality of servers each having resources and a controller capable of communicating with both the plurality of servers and the client terminal(s). The controller has a first unit configured to generate successive identifiers in correspondence to the order of reception for the requests received from the client, terminal(s) and attach the identifier to each request, and to transmit the requests to the server. The server has a second unit configured to determine whether or not there exists a request (a) not received yet between the request received the previous time and the request received this time, and a third unit configured to make an inquiry about the information on the contents of the change in the resources that should be changed in correspondence to the request (s) not received yet in the case where it is determined that there exists a request(s) not received yet.

According to the controller that is disclosed in the present specification, the controller is a controller in the above-described information processing system and includes an identification number generation unit configured to generate successive identification numbers and a memory for recording information about the generated identification numbers. The controller refers to the memory storing the identification numbers for requests received from a client terminal, reads information about the generated identification numbers for the received requests, generates successive identification numbers by the identification number generation unit configured to generate successive identification numbers for the requests received this time, attaches the successive identification numbers to the received requests, transmits the requests to the plurality of servers, generates responses based on one or a plurality of responses received from the plurality of servers, and transmits the responses to the client terminal having transmitted the requests.

According to the server that is disclosed in the present specification, the server is a server in the above-described information processing system having the above-described controller and performs a predetermined processing in accordance with a request in the case where the identification number of this time attached to the received request and the identification number of the previous time attached to the request received the previous time are successive, numbers and stores the contents of the change made to the resources in correspondence to the contents of the processing in association, with the identification number. In the case where the identification number of this time attached to the received request and the identification number of the previous time attached to the request received the previous time are not successive numbers, the server receives the contents of the change in the resources associated with a missing identification number(s) located between the identification number of this time and the identification number of the previous time from another of the servers and after changing the resources by reflecting the contents of the change in the resources associated with the missing identification number(s) in the resources, performs predetermined processing in accordance with the request and stores the contents of the change made to the resources in correspondence to the contents of the processing in association with the identification number.

According to the above-described information processing system that is disclosed an the present specification, an information processing system that does not stop the operation is obtained, as long as one server is in normal state, by providing with adequate number of the servers in accordance with the required reliability.

Further, according to the above-described information processing method that is disclosed in the present specification, it is possible to operate the information processing system without stopping the information processing system, as long as one server is in normal state, by providing with adequate number of the servers in accordance with the required reliability.

### BRIEF DESCRIPTION OF DRAWINGS

FIG. 1 is a system configuration diagram of a first embodiment of a system that is disclosed in the present specification.

FIG. 2 is a configuration diagram of a controller.

FIG. 3 is a diagram explaining a server list table.

FIG. 4 is a configuration diagram of a server.

FIG. 5 is a diagram explaining an access point position information table.

FIG. 6 is a diagram explaining a terminal position information table.

FIG. 7 is a diagram explaining a server address table.

FIG. 8 is a configuration diagram or a client terminal.

FIG. 9 is a flowchart (part 1) explaining the operation of the first embodiment of the system.

FIG. 10 is a flowchart (part 2) explaining the operation of the first embodiment of the system.

FIG. 11 is a flowchart (part 3) explaining the operation of the first embodiment of the system.

FIG. 12 is a flowchart (part 4) explaining the operation of the first embodiment of the system.

FIG. 13 is a flowchart (part 5) explaining the operation of the first embodiment of the system.

FIG. 14 is a flowchart (part 6) explaining the operation of the first embodiment of the system.

FIG. 15 is a configuration diagram of a controller of a second embodiment that is disclosed in the present specification.

FIG. 16 is a configuration diagram of a distribution unit.

FIG. 17 is a diagram explaining a sub controller list table.

FIG. 18 is a flowchart (part 1) explaining the operation of the second embodiment of the system.

FIG. 19 is a flowchart (part 2) explaining the operation of the second embodiment of the system.

FIG. 20 is a system configuration diagram of a third embodiment that is disclosed in the present specification.

FIG. 21 is a diagram explaining a server list table.

FIG. 22 is a flowchart (part 1) explaining the operation of the third embodiment of the system.

FIG. 23 is a flowchart (part 2) explaining the operation of the third embodiment of the system.

FIG. 24 is a flowchart (part 3) explaining the operation of the third embodiment of the system.

FIG. 25 is a flowchart (part 4) explaining the operation of the third embodiment of the system.

### DESCRIPTION OF EMBODIMENTS

Hereinafter, a favorable first embodiment of an information processing system that is disclosed in the present specification is explained with reference to the drawings. However, the technical scope of the present invention is not limited to the embodiments and encompasses the inventions described in the claims and equivalents thereof.

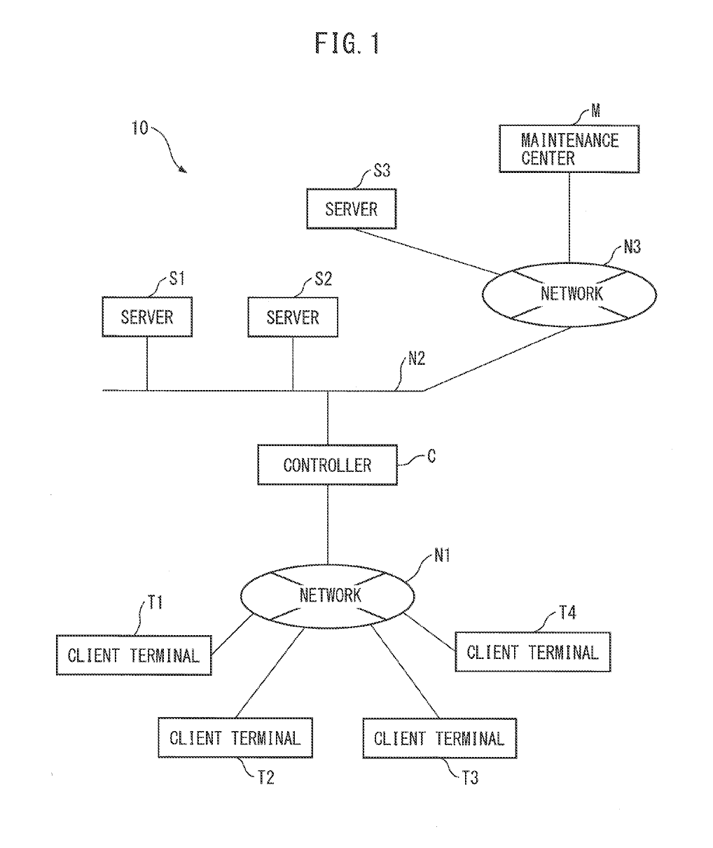

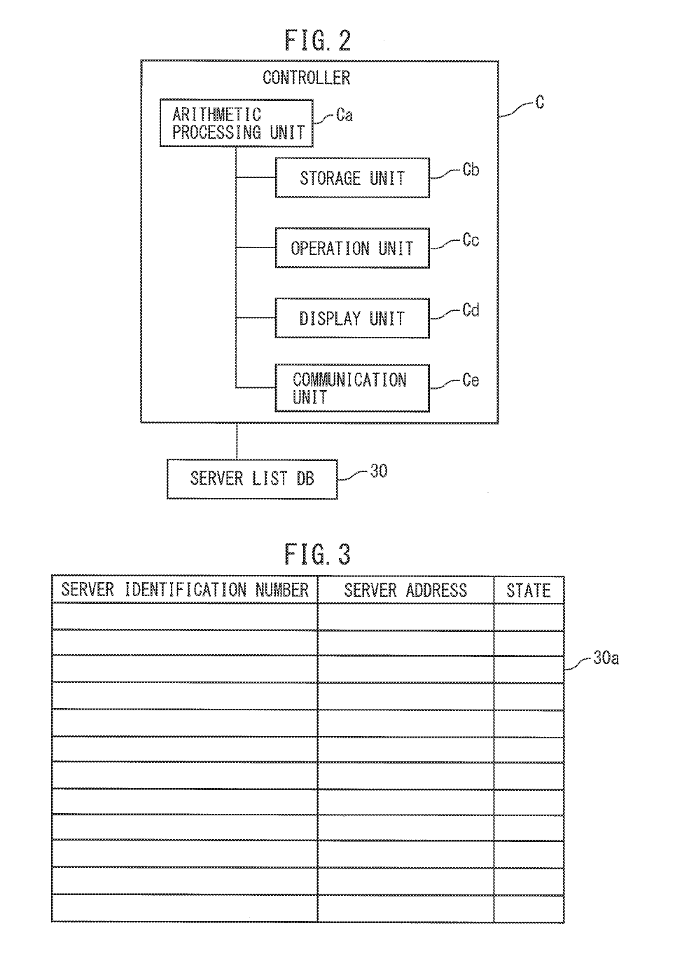

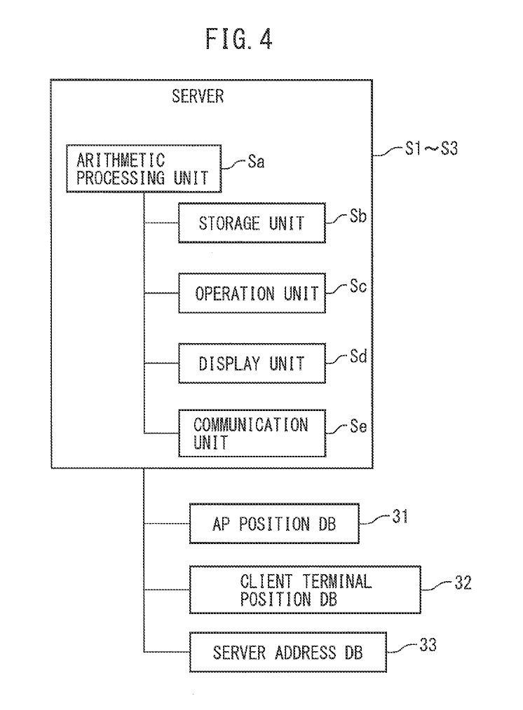

FIG. 1 is a system configuration diagram of the first embodiment of the information, processing system (hereinafter, also referred to simply as a system) that is disclosed in the present specification. FIG. 2 is a configuration diagram of a controller. FIG. 4 is a configuration diagram of a server. FIG. 8 is a configuration diagram of a client terminal.

In a system 10 of the present embodiment, servers S1 to S3 having resources perform predetermined processing in accordance with a request received from client terminals T1 to T4 and create a response and at the same time, change the resources in correspondence to the contents of the processing and transmit the response to one of the client terminals T1 to T4.

The request is a request for processing from the client terminal to the servers and the response is the result of the processing performed by the servers in accordance with the request.

The resource is a database, a file, a memory, an information output unit, or a combination thereof possessed by the server.

The system 10 has redundancy by including a plurality of servers S1 to S3 that perform predetermined processing in response to a request from the client terminals T1 to T4 and creates a response. In the example illustrated in FIG. 1, the system 10 includes the three servers S1 to S3, but the number of servers is not limited in particular as long as there are two or more servers.

It is possible for the system 10 to continue operation without stopping, for example, even in the case where the one or two servers have stopped their operation due to a failure, or where communication with the one or two servers has broken down due to trouble in the network, or where data has been lost due to a failure in the one or two servers. Further, even in the case where the state where the one or two servers no longer operate has been brought about, a special operation to switch the failed server (s) to the normal server (s) is not necessary.

Furthermore, in the system 10, when the failed server is replaced with the server that functions normally, it is possible for the new server with which the failed server has been replaced to synchronize with the resources of the other servers by automatically updating the resources.

As illustrated in FIG. 1, the system 10 includes a controller C connected with the plurality of client terminals T1 to T4 via a network N1 so as to be capable of performing communication, and the plurality of servers S1 to S3 connected with the controller C via a network N2 so as to be capable of performing communication.

The server S3 is connected with the controller C via a network N3 connected with the network N2 so as to capable of performing communication.

As the network N1, for example, Ethernet (registered trademark), a wireless LAN such as WiFi (registered trademark), and a wide area network such as the Internet can be used.

As the network N2, for example, a local area network such as Ethernet (registered trademark) can be used. As the network N3, for example, a wide area network such as the Internet can be used.

The controller C attaches successive identification numbers to the requests received from the client terminals T1 to T4 and transmits the received requests to the plurality of servers S1 to S3. The identification numbers are the same between the servers S1 to S3. Further, the controller C transmits one of the responses received from the plurality of servers S1 to S3 to one of the client terminals T1 to T4 having transmitted the request.

As illustrated in FIG. 2, the controller C has an arithmetic processing unit Ca, a storage unit Cb, an operation unit Cc, a display unit Cd, and a communication unit Ce.

The arithmetic processing unit Ca performs control of each element of the controller C and various kinds of processing in accordance with predetermined programs stored in advance in the storage unit Cb and uses the storage unit Cb in order to temporarily save data that is produced during processing. The storage unit Cb may have a primary storage device and a secondary storage device. The storage unit Cb records information about the generated identification numbers.

The operation unit Cc is operated by an administrator, etc., of the system 10 to input various kinds of information. As the operation unit Cc, it is possible to use, for example, a keyboard or a mouse. It may also be possible to design a configuration in which an administrator does not use the operation unit Cc but performs the operation by using a terminal such as a personal computer connected to the network N2. The arithmetic processing unit Ca performs various kinds of processing by using various kinds of information input from the operation unit Cc.

The display unit Cd displays various kinds of information in accordance with the operation of the arithmetic processing unit Ca. As the display unit Cd, it is possible to use, for example, a liquid crystal panel.

The communication unit Ce performs data transmission and reception with the client terminals T1 to T4 via the network N1. Further, the communication unit Ce performs data transmission and reception with the servers S1 to S3 and a maintenance center N via the network N2 and the network N3.

As the controller C, it is possible to use, for example, a computer, a one-chip microcomputer, a state machine, or the like. By the arithmetic processing unit Ca performing control of each element of the controller C and various kinds of processing in accordance with predetermined programs stored in advance in the storage unit Cb, an identification number generation unit configured to refer to a memory recording identification numbers for requests received from the client terminal, to read information about the identification numbers generated for the requests received the previous time, and to generate successive identification numbers for the requests received this time is implemented.

Further, as illustrated in FIG. 2, the controller C has a server list database (DB) 30 storing a list of the servers possessed by the system 10. In the server list DB 30, a server list table 30a is stored.

FIG. 3 is a diagram explaining a server list table.

In the server list table 30a, a server identification number for identifying a server, a server address, and a state indicating the presence/absence of an abnormality of a server are recorded in association with one another.

The controller C transmits the server identification number and the server address of the server that is working to each server when the system 10 is activated or a change occurs.

The servers S1 to S3 create a response in accordance with a request received from the controller C and transmit the created response to the controller C.

As illustrated in FIG. 4, each of the servers S1 to S3 has an arithmetic processing unit Sa, a storage unit Sb, an operation unit Sc, a display unit Sd, and a communication unit Se.

The arithmetic processing unit Sa performs control of each element of the servers S1 to S3 and various kinds of processing in accordance with predetermined programs stored in advance in the storage unit Sb and uses the storage unit Sb in order to temporarily save data that is produced during processing. The storage unit Sb may have a primary storage device and a secondary storage device.

The operation unit Sc is operated by an administrator, etc., of the system 10 to input various kinds of information. As the operation unit Sc, it is possible to use, for example, a keyboard or a mouse. The arithmetic processing unit. Sa performs various kinds of processing by using various kinds of information input from the operation unit Sc.

The display unit Sd displays various kinds of information in accordance with the operation of the arithmetic processing unit. Sa. As the display unit Sd, it is possible to use, for example, a liquid crystal panel.

The communication unit Se performs data transmission and reception with the controller C or another server via the network N2 or the network N3. By the arithmetic processing unit Sa performing control of each element of the servers S1 to S3 and various kinds of processing in accordance with predetermined programs stored in advance in the storage unit. Sb, a unit configured to determine whether or not there exists a request (s) that has not been received yet between the request received the previous time and the request received this time by making use of the successiveness of the identifiers attached to the requests received from the controller is implemented. Further, by the arithmetic processing unit Sc performing control of each element of the servers S1 to S3 and various kinds of processing in accordance with predetermined programs stored in advance in the storage unit Sb, a unit configured to make an inquiry to another server about information on the contents of the change in the resources that should be changed in correspondence to the request (s) not received yet is implemented.

In the present embodiment, explanation is given in conformity with the application, to a position information service system in which the position of the client terminal is measured based on the intensity of the radio wave of the radio communication, the measured position of the client terminal is recorded in the database, and the position information on the client terminal is returned to the inquiry from the client terminal. Specifically, in the system 10, as the network N1, a wireless LAN such as WiFi (registered trademark) is used, and the controller C and the plurality of client terminals T1 to T4 are connected with each other via three access points AP1 to AP3, not illustrated, so as to be capable of performing communication. In the present embodiment, three access points are provided, but the number of access points is not limited in particular. As illustrated in FIG. 4, each of the servers S1 to S3 has an access point position database (AP position DB) 31 that stores the positions of the access points AP1 to AP3 possessed by the system 10, a client terminal position database (DB) 32 that stores the positions of the client terminals, and a server address database (DB) 33 that stores the addresses of the other servers.

In the AP position DB 31, an access point position information table 31a is stored.

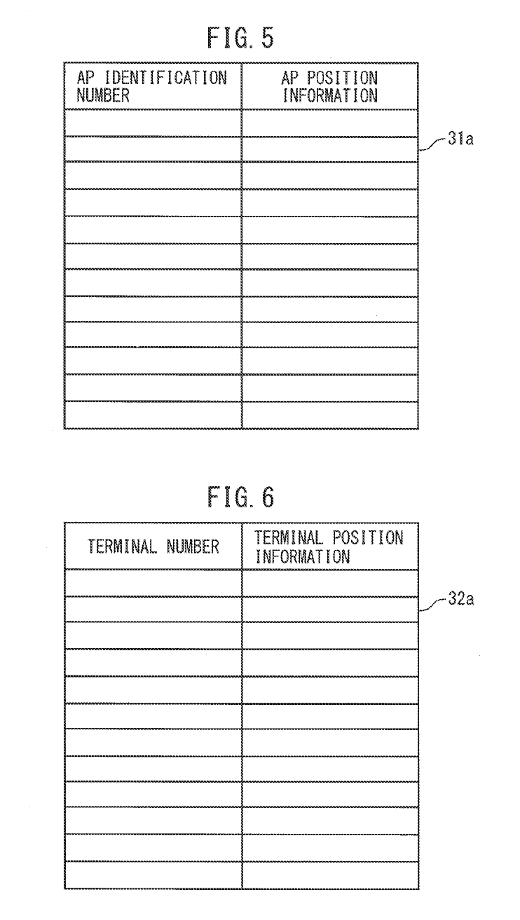

FIG. 5 is a diagram explaining the access point position information table.

In the access point position information table 31a, an AP identification number for identifying an access point and AP position information indicative of the position of an access point are recorded in association with each other.

In the client terminal, position DC 32, a terminal position information table 32a is stored.

FIG. 6 is a diagram explaining the terminal position information table.

In the terminal position information table 32a, a terminal number for identifying a client terminal and terminal position information indicative of the position of a client terminal are recorded in association with each other.

In the server address DB 33, a server address table 33a is stored.

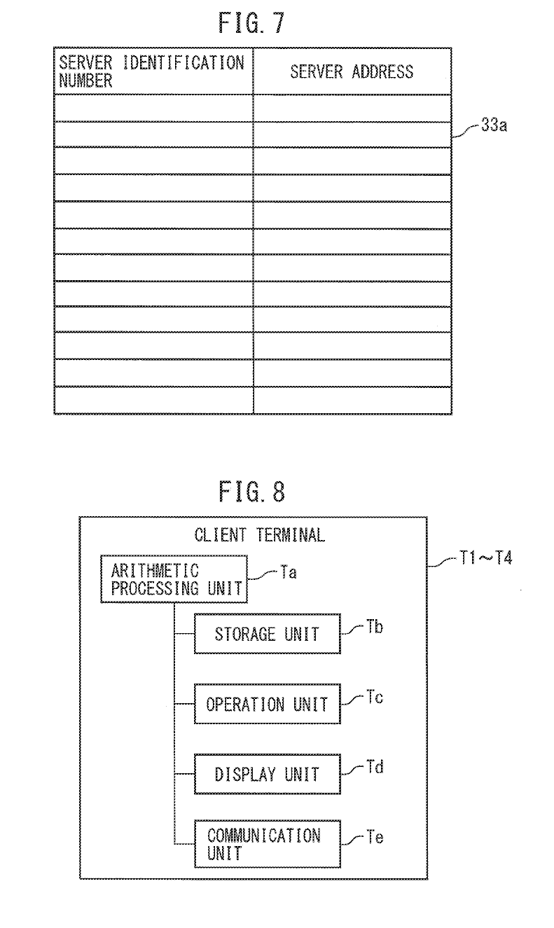

FIG. 7 is a diagram explaining the server address table.

In the server address table 33a, a server identification, number for identifying a server and a server address are recorded in association with each other. The servers S1 to S3 record the identification number and the server address of the server that is working, which have been received from the controller C, in the server address table 33a.

The client terminals T1 to T4 transmit a request to the controller C and receive a response from the controller C.

As illustrated in FIG. 8, each of the client terminals T1 to T4 has an arithmetic processing unit Ta, a storage unit Tb, an operation unit. Tc, a display unit. Td, and a communication unit Te.

The arithmetic processing unit Ta performs control of each element of the client terminals T1 to T4 and various kinds of processing in accordance with predetermined programs stored in advance in the storage unit Tb and uses the storage unit Tb in order to temporarily save data that is produced during processing. The storage unit Tb may have a primary storage device and a secondary storage device.

The operation unit Tc is operated by an operator, etc., of the client terminal to input various kinds of information. As the operation unit Tc, it is possible to use, for example, a touch panel. The arithmetic processing unit Ta performs various kinds of processing by using various kinds of information input from the operation unit Tc.

The display unit Td displays various kinds of information in accordance with the operation of the arithmetic processing unit Ta. As the display unit Td, it is possible to use, for example, a liquid crystal panel.

The communication unit Te performs data transmission and reception with the controller C via the network N1.

As the client terminals T1 to T4, it is possible to use, for example, a multifunction mobile telephone, a tablet terminal, a notebook personal computer, etc.

To the network N1, the maintenance center N is connected. The controller C transmits the server identification number of the server that has been determined to have an abnormality to the mail address of the maintenance center N via the network N3 by using an electronic mail. An administrator of the maintenance center N performs maintenance of the reported server by using an electronic mail.

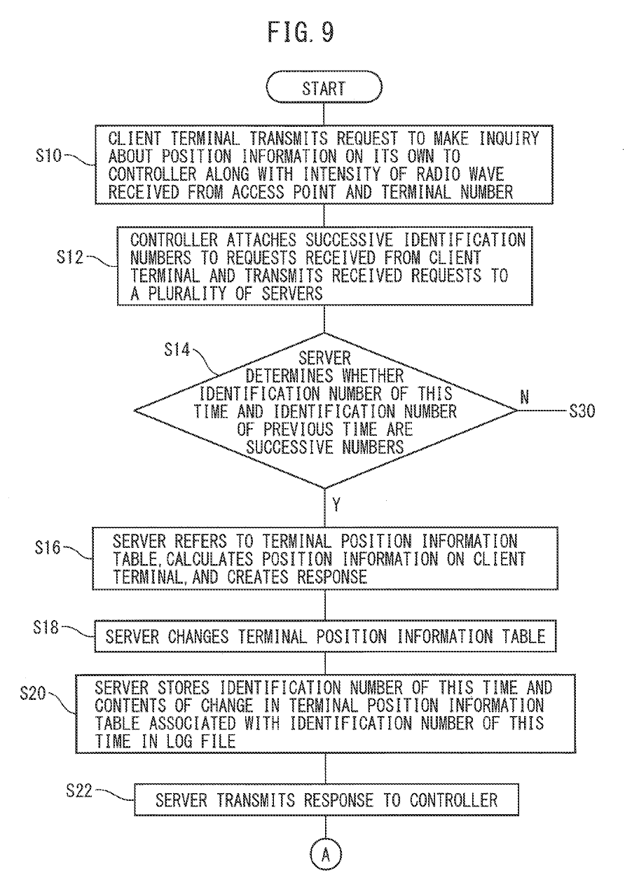

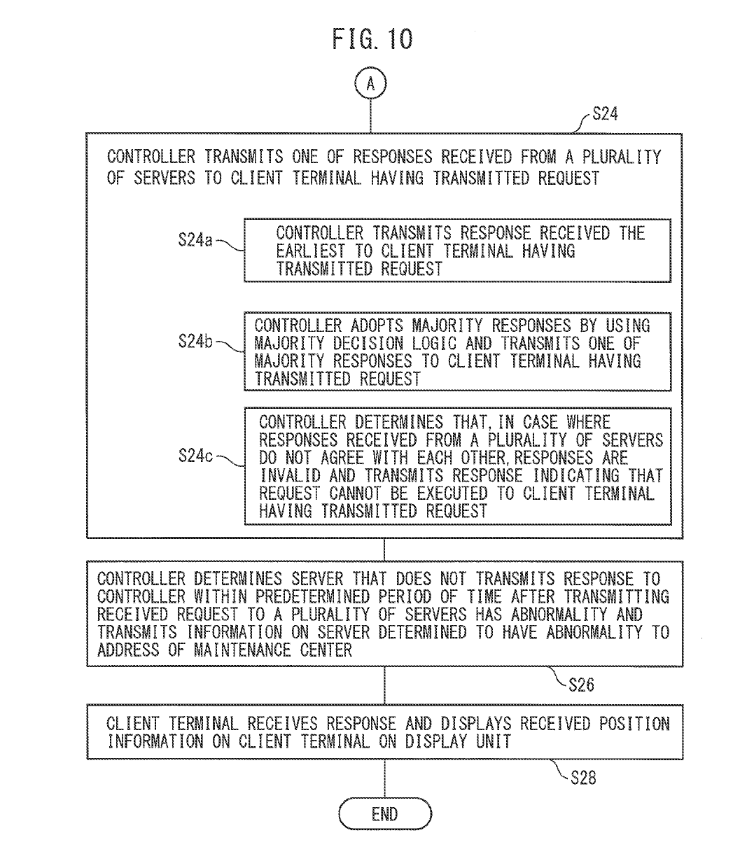

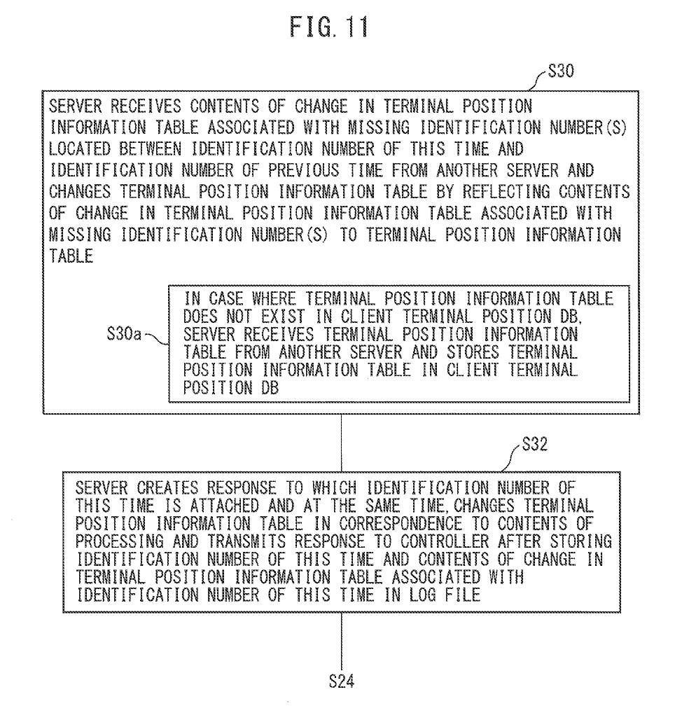

A first operation example of the system 10 described above is explained below with reference to FIG. 9 to FIG. 11.

In the first operation example of the system 10, in response to a request from the client terminal, which makes an inquiry about position information on the client terminal itself, the server calculates the position information on the client terminal and the controller transmits a response to the client terminal.

First, at step S10, each of the client terminals T1 to T4 transmits a request to make an inquiry about position information on the client terminal itself to the controller C along with the intensities of the radio wave received from the three access points AP1 to AP3 and the terminal number. The terminal number may be one of the MAC address and the IP address.

In the example illustrated in FIG. 1, each of the client terminals T1 to T4 has already received the radio waves from the three access points AP1 to AP3 and has already measured the intensity of the radio wave from each of the access points by using the communication unit Te.

Because an operator of the client terminal carries the client terminal while moving, the distance between the client terminal and each of the access points AP1 to AP3 varies, and therefore, the intensity of the radio wave from each of the access points also varies in accordance with the position of the client terminal.

Next, at step S12, the controller C attaches successive identification numbers to the requests received from the client terminal and transmits the received requests to the plurality of servers S1 to S3. The identification number is a number having uniqueness for distinguishing one request from other requests. As the identification numbers, integers having a sufficient number of digits so as to be capable of representing a sufficiently large number may be used in view of the number of requests that are executed within the unit running time of the system. It is possible to generate successive identification numbers so that the increment between neighboring identification numbers is 1. The identification number next the identification number represented by the maximum number that can be represented by the integers with the same number of digits may be 0. The controller C refers to the server list table 30a and transmits the requests to the servers having no abnormality.

Next, at step S14, each of the servers S1 to S3 determines whether the identification number of this time attached to the received request and the identification number of the previous time attached to the request received the previous time are successive numbers. In the case where the identification numbers are successive numbers, the processing proceeds to step S16. On the other hand, in the case where the identification numbers are not successive numbers, the processing proceeds to step S30.

In the case where the processing proceeds to step S16, each of the servers S1 to S3 refers to the terminal position information table 31a, calculates the position information on the client terminal having transmitted the request, and creates a response. The storage unit Sb of each of the servers S1 to S3 stores a program that refers to the terminal position information table 31a, calculates the distance between the client terminal and each access point based on the intensity of radio wave form each of the three access points AP1 to AP3, and further finds position information on the client terminal from the position data on each access point and the distance data thereof. Each of the servers S1 to S3 executes the program to calculate the position information on the client terminal.

Next, at step S18, in the case where the calculated position information on the client terminal is not recorded in the terminal position information table 31a, each of the servers S1 to S3 records the position information in association with the identification number of the client terminal. Further, in the case where the calculated position information on the client terminal is different from the position information recorded in the terminal position information table 31a, each of the servers S1 to S3 updates the recorded position information on the client terminal to the position information calculated this time. In this manner, each of the servers S1 to S3 changes the resources in accordance with the contents of the processing.

Next, at step S20, each of the servers S1 to S3 stores the identification number of this time and the contents of the change in the terminal position information table 31 associated with the identification number of this time in a log file as a log. The log file is stored in the storage unit Sb.

Next, at step S22, each of the servers S1 to S3 transmits the calculated position information to the controller C as a response. The order of steps S18 to S22 may be changed.

Next, at step S24, the controller C removes the identification number from one of the responses received from the plurality of servers S1 to S3 and transmits the response to one of the client, terminals T1 to T4 having transmitted the request. As a method for selecting one of the responses received from the plurality of servers S1 to S3, it is possible for the controller C to use, for example, the following method. In this method, it may also be possible for the controller C to generate a response to be transmitted to the client terminal having transmitted the request based on one of the responses received from the plurality of servers. Alternatively, it may also be possible for the controller C to generate a response to be transmitted to the client terminal having transmitted the request based on a plurality of responses received from the plurality of servers.

In the example illustrated at step S24a, the controller C transmits the response that has been received the earliest of the responses received from the plurality of servers S1 to S3 to one of the client terminals T1 to T4 having transmitted the request.

In the example illustrated at step S24b, the controller C determines majority responses by using majority decision logic for the responses received from the plurality of servers S1 to S3 and transmits one of the majority responses to one of the client terminals T1 to T4 having transmitted the request.

In the example illustrated at step S24c, in the case where the responses received from the plurality of servers S1 to S3 do not agree with one another, the controller C determines that the responses are invalid and transmits a response indicating that the predetermined processing in correspondence to the request cannot be performed to one of the client terminals T1 to T4 having transmitted the request.

Next, at step S26, the controller C determines that the server that does not transmit a response to the controller C within a predetermined period of time after transmitting the received request to the plurality of servers S1 to S3 has an abnormality, and transmits the server identification number of the server determined, to have an abnormality to the mail address of the maintenance center M via the network N3 by using an electronic mail.

Then, the controller C records a flag indicating that there is an abnormality in the server list table 30a as the state of the server having an abnormality. The server for which the flag indicating that there is an abnormality is recorded as the state is determined to be the server that is not working. Then, the controller C transmits the server identification number and the server address of the server that is working to each server.

Next, at step S28, one of the client terminals T1 to T4 having transmitted the request receive the response from the controller C and display the received position information on the client terminal on the display unit Td.

On the other hand, in the case where the identification numbers are not successive numbers at step S14, the processing proceeds to step S30. Examples of the case where identification numbers are not successive numbers are the case where the server has stopped the operation due to a failure, the case where the communication between the controller and the server has been broken down due to trouble in the network, the case where data has been lost due to a failure in the server, etc. The server having an abnormality such as this is in the state where the server cannot receive a request or where the server cannot perform processing in accordance with a request normally even if a request is transmitted. Because of this, the sever having an abnormality cannot receive the identification number attached to a request or cannot complete the processing in accordance with a request normally, and therefore, there exists a missing identification number.

In the case where the processing has proceeded to step S30, one of the servers S1 to S3 receives the contents of the change in the terminal position information table 31a associated with the missing identification number(s) located between the identification number of this time and the identification number of the previous time from another server and changes the terminal position information table 31a by reflecting the contents of the change in the terminal position information table 31a associated with the missing identification number(s) to the resources. One of the servers S1 to S3 refers to the server address table 33a and communicates with another server. The other server refers to the log file and transmits the contents of the change in the terminal position information table 31a associated with the missing identification number(s) about which an inquiry has been made to one of the servers S1 to S3. Here, there may be a case where the terminal position information table 31a does not exist in the client terminal position DB 32 due to the loss of data etc.

In the case such as this, as illustrated at step S30a, one of the servers S1 to S3 receives the terminal position information table 31a from another server and stores the terminal position information table 31a in the client terminal position DB 32.

Next, at step S32, one of the servers S1 to S3 performs predetermined processing in accordance with the received request and creates a response to which the identification number of this time is attached and at the same time, changes the terminal position information table 31a in correspondence to the contents of the processing, transmits the response to the controller C, and stores the identification number of this time and the contents of the change in the terminal position information table 31a associated with the identification number of this time in the log file as a log. Then, the processing proceeds to step S24.

In this manner, one of the servers S1 to S3 synchronizes with the resources of another server. The server having synchronized with another server notifies the controller C of that the server itself can work and the controller C updates the state of the corresponding server within the server list table 30a to the state of having no abnormality.

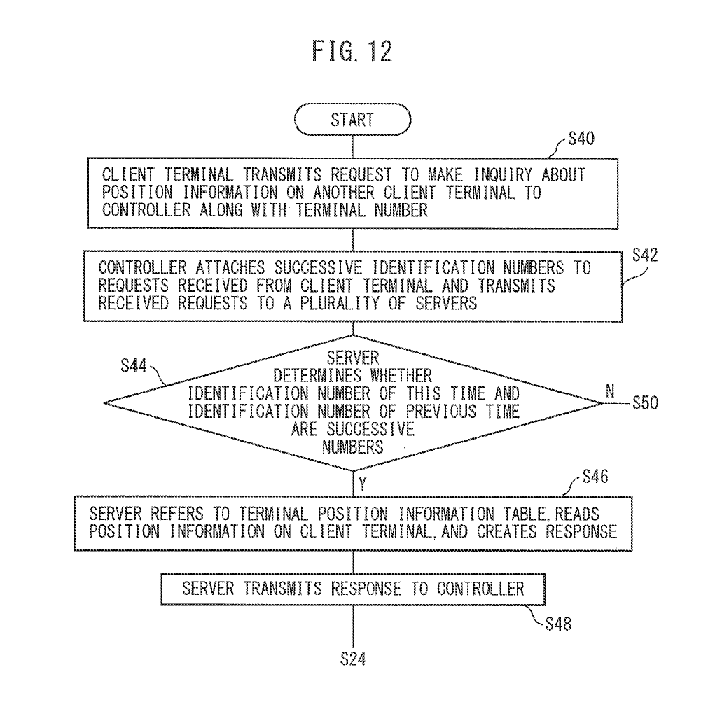

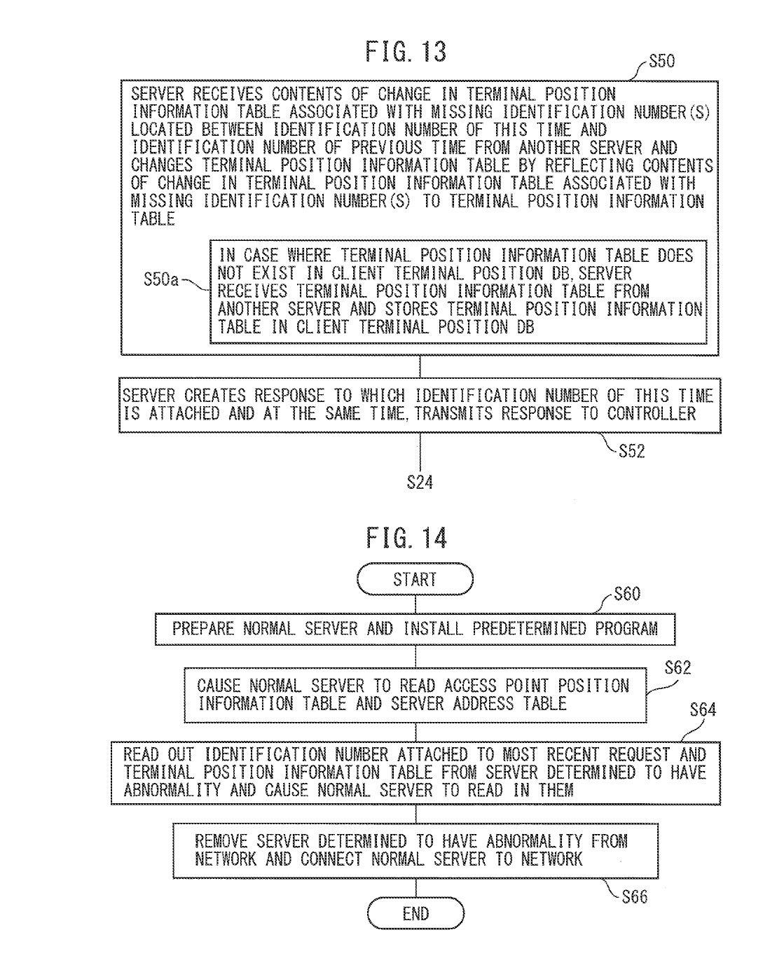

Next, a second operation example of the system 10 described above is explained below with reference to FIG. 12 and FIG. 13.

In the second operation example of the system. 10, the server creates a response by reading the position information on the client terminal for which the server is specified from the terminal position information table 31a for the request from one client terminal, to make an inquiry about the position information on another client terminal, and the controller transmits the response to the client terminal having made the inquiry.

First, at step S40, one of the client terminals T1 to T4 transmits a request to make an inquiry about the position information on another of the client terminals T1 to T4 to the controller C along with the terminal number.

Next, at step S42, the controller C attaches successive identification numbers to the requests received from the one of the client terminals T1 to T4 and transmits the received requests to the plurality of servers S1 to S3.

Next, at step S44, each of the servers S1 to S3 determines whether the identification number of this time attached to the received request and the identification number of the previous time attached to the request received the previous time are successive numbers. In the case where the identification numbers are successive numbers, the processing proceeds to step S46. On the other hand, in the case where the identification numbers are not successive numbers, the processing proceeds to step S50.

In the case where the processing has proceeded to step S46, each of the servers S1 to S3 refers to the terminal position information table 31a, reads the position information on another of the client terminals T1 to T4, and creates a response. In this processing, the contents of the terminal position information table 31a are not changed.

Next, at step S48 each of the servers S1 to S3 transmits the response to the controller C. The operation of the system 10 after this is the same as that at steps S24 to S28 described above.

On the other hand, in the case where the identification numbers are not successive numbers at step S44, the processing proceeds to step S50.

In the case where the processing has proceeded to step S50, one of the servers S1 to S3 receives the contents of the change in the terminal position information table 31a associated with the missing identification number(s) located between the identification number of this time and the identification number of the previous time from another server and changes the terminal position information table 31a by reflecting the contents of the change in the terminal position information table 31a associated with the missing identification number(s) to the resources. In the case where the identification numbers are not successive numbers, there is a possibility that the position information on the client terminal that is recorded in the terminal position information table 31a is not the most recent information. Because of this, as described above, the processing to update the terminal position information table 31a is performed. There may be a case where the terminal position information table 31a does not exist in the client terminal position DB 32 due to the loss of data etc.

In the case such as this, as illustrated at step S50a, one of the servers S1 to S3 receives the terminal position information table 31a from another of the server S1 to S3 and stores the terminal position information table 31a in the client terminal position DB 32.

Next, at step S52, one of the servers S1 to S3 performs predetermined processing in accordance with the received request, creates a response to which the identification number of this time is attached, and transmits the response to the controller C. The operation of the system 10 after this is the same as that at steps S24 to S28 described above.

In the second operation example described above, the controller C attaches successive identification numbers to the requests received from the client terminals T1 to T4, but to requests not accompanied by the change in the resources, successive identification numbers may not be attached. Further, in the case of a request not accompanied by the change in the resources, it may also be possible for the controller C to transmit the request only to the server (a) whose physical distance is short (e.g., the servers S1 and S2), but not to the server (s) whose physical distance is long (e.g., the server S3). Furthermore, in the case of a request not accompanied by the change in the resources, it may also be possible for the controller C to assign priorities to the servers and to transmit the request to the servers in the order from the server having the highest priority. The priority of the server may be determined based on the processing power of the server.

Next, the procedure to replace a server determined to have an abnormality with another server that functions normally and to connect the normal server to the network is explained below with reference to FIG. 14.

First, at step S60, a server that functions normally is prepared and predetermined programs are installed therein.

Next, at step S62, an inquiry is made to the server that is working and the server that functions normally is caused to read the access point position table 31a and the server address table 33a. The access point position table 31a is stored in the AP position DB 31 and the server address table 33a is stored in the server address DB 33.

Next, at step S64, the identification number attached to the most recent request and the terminal position information table are read out from a server determined to have an abnormality and the server that functions normally is caused to read in them. This step may not be performed in the case where the identification number attached to the most recent request and the terminal position information table cannot be read out from the server determined to have an abnormality.

Next, at step S66, the server determined to have an abnormality is removed from the network and the server that functions normally is connected to the network. It is possible for the server that functions normally to synchronize with the resources of the other servers by automatically updating the resources when performing processing in accordance with the request.

The system of the embodiment described above has redundancy such that each of the plurality of servers has the same resources and performs the same operation while maintaining the synchronization of the resources, and therefore, it is possible to continue the operation without stopping the system. Further, in the system 10, the task to switch the running server that has failed to the standby server is not necessary, and therefore, the time taken for switching and switching task is no longer necessary. Furthermore, the procedure to replace the failed server with a normal server is simple, and therefore, replacement and restoration can be performed securely.

Another embodiment of the above-described system is explained below with reference to the drawings. To the points that are not explained in particular in another embodiment, the detailed explanation given for the first embodiment described above are applied appropriately. The same symbols are attached to the same components.

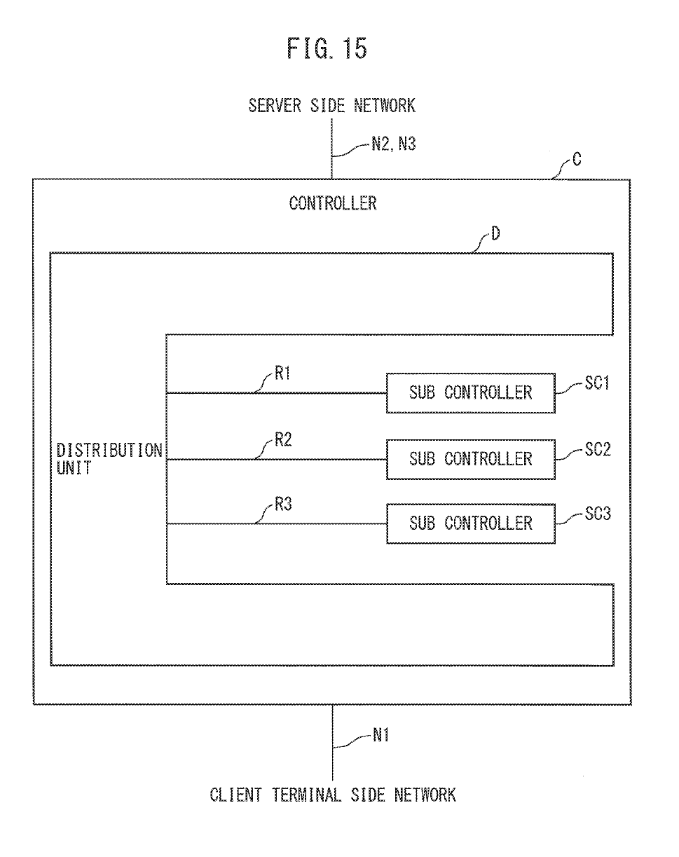

FIG. 15 is a configuration diagram of a controller of a second embodiment of the system that is disclosed in the present specification.

In the system 10 of the present embodiment, the controller C has a distribution unit. D and a plurality of sub controllers SC1 to SC3. Each of the plurality of sub controllers SC1 to SC3 has the same function as that of the controller of the first embodiment described above. In other words, the controller C of the system of the present embodiment has redundancy in contrast to the controller of the first embodiment described above.

The distribution unit D transmits requests received from the client terminals T1 to T4 to the plurality of sub controllers SC1 to SC3 and transmits one of the requests received from the sub controllers SC1 to SC3 and to which identification numbers are attached to the plurality of servers S1 to S3. Further, the distribution unit D transmits responses received from the plurality of servers S1 to S3 to the plurality of sub controllers SC1 to SC3 and transmits one of the responses received from the plurality of sub controllers SC1 to SC3 to the client terminals T1 to T4 having transmitted the requests.

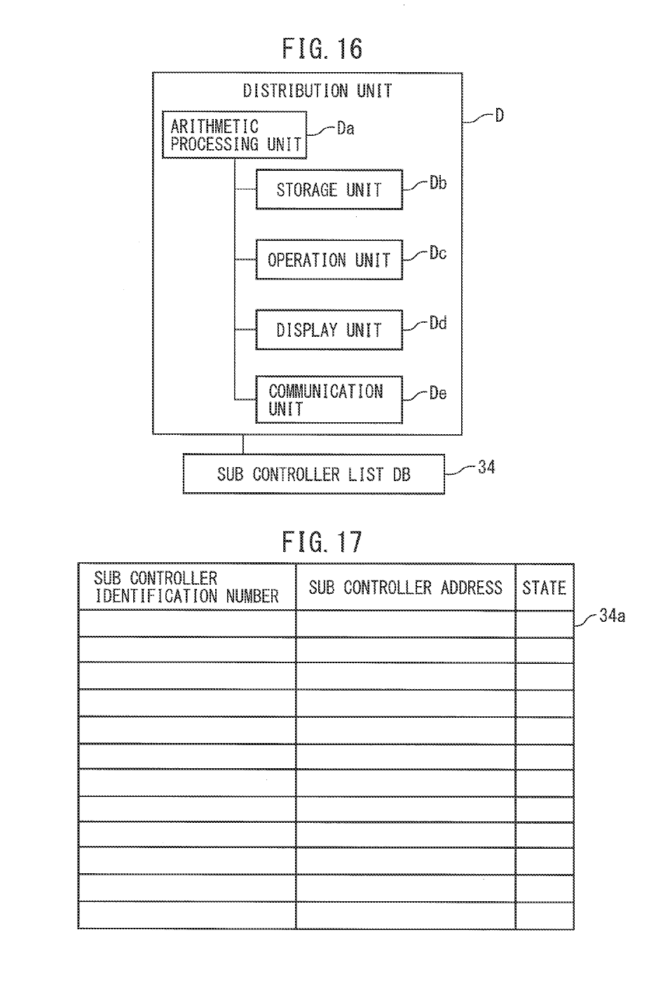

As illustrated in FIG. 16, the distribution unit D has an arithmetic processing unit Da, a storage unit Db, an operation unit Do, a display unit Dd, and a communication unit De.

The arithmetic processing unit Da performs control of each element of the distribution unit D and various kinds of processing in accordance with predetermined programs stored in advance in the storage unit Db and uses the storage unit Db in order to temporarily save data that is produced during processing. The storage unit Db may have a primary storage device and a secondary storage device.

The operation unit. Dc is operated by an administrator etc. of the system 10 to input various kinds of information. As the operation unit Dc, it is possible to use, for example, a keyboard or a mouse. The arithmetic processing unit Da performs various kinds of processing by using various kinds of information input from the operation unit Dc it may also be possible to design a configuration in which an administrator does not use the operation unit. Dc but performs operations by using a terminal such as a personal computer connected to the network N2.

The display unit Dd displays various kinds of information in accordance with the operation of the arithmetic processing unit Da. As the display unit Dd, it is possible to use, for example, a liquid crystal panel.

The communication unit be performs data transmission and reception with the client terminals T1 to T4 via the network N1. Further, the communication unit De performs data transmission and reception with the servers S1 to S3 via the network N2 and the network N3. Furthermore, the communication unit De performs data transmission and reception with the sub controllers SC1 to SC3 via links R1 to R3.

As illustrated in FIG. 16, the distribution unit D has a sub controller list database (DB) 34 storing a list of the sub controllers possessed by the controller C. In the sub controller list DB 34, a sub controller list table 34a is stored.

FIG. 17 is a diagram explaining a sub controller list table.

In the sub controller list table 34a, a sub controller identification number for identifying a sub controller possessed by the controller C, a sub controller address, and a state indicating the presence/absence of an abnormality in a sub controller are recorded in association with one another.

Each of the sub controllers SC1 to SC3 has the same configuration and function as those of the controller of the first embodiment described above.

The sub controllers SC1 to SC3 attach successive identification numbers to the requests received from the distribution unit C and transmit the received requests to the distribution unit. Further, the sub controllers SC1 to SC3 transmit one of the responses received from the plurality of servers S1 to S3 to the distribution unit D.

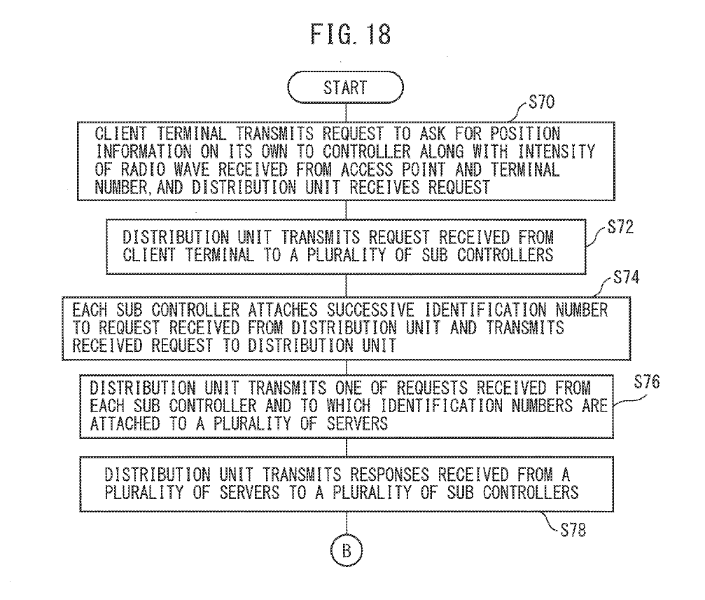

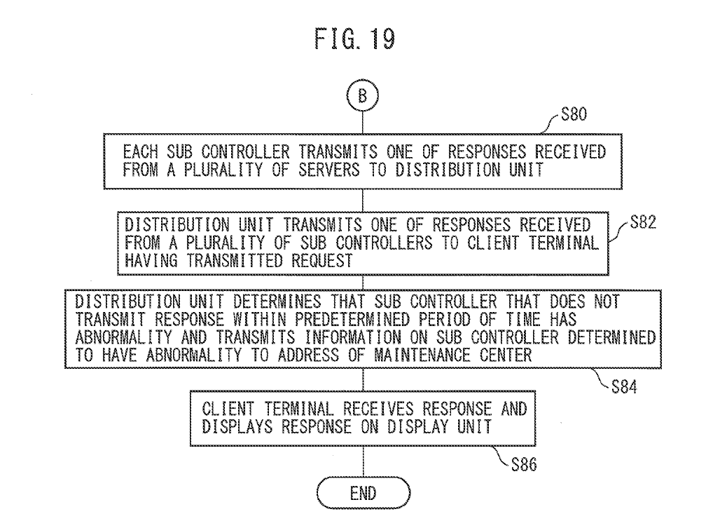

Next, an operation example of the system 10 described above of the present specification is explained below with reference to FIG. 18 and FIG. 19.

First, at step S70, one of the client terminals T1 to T4 transmits a request to ask for information, on the position of their own to the controller C along with the intensities of radio wave received from the three access points AP1 to AP3 and the terminal number, and the distribution unit D receives the request.

Next, at step S72, the distribution unit D transmits the request received from the client terminals T1 to T4 to the plurality of sub controllers SC1 to SC3.

Next, at step S74, each of the sub controllers SC1 to SC3 attaches successive identification number to the request received from the distribution unit D and transmits the received request to the distribution unit D. Each of the sub controllers SC1 to SC3 performs the same operation, and therefore, attaches the same identification number to one and the same request.

Next, at step S76, the distribution unit D transmits one of the requests received from each of the sub controllers SC1 to SC3 and to which identification numbers are attached to the plurality of servers S1 to S3. Then, each of the servers S1 to S3 performs the operations at steps S14 to S22 or at steps S30 to S32 described above and transmits responses to the controller C, and the distribution unit D receives the responses.

Next, at step S73, the distribution unit D transmits the responses received from each of the plurality of servers S1 to S3 to the plurality of sub controllers SC1 to SC3.

Next, at step S80, each of the sub controllers SC1 to SC3 transmits one of the responses received from the plurality of servers S1 to S3 to the distribution unit D. Each of the sub controllers SC1 to SC3 performs the same processing as that at step S24 described above.

Next, at step S82, the distribution unit D transmits one of the responses received from the plurality of sub controllers SC1 to SC3 to one of the client terminals T1 to T4 having transmitted the request. Priorities are assigned to the plurality of sub controllers SC1 to SC3 and it is possible for the distribution unit D to select the request that is transmitted to the client terminal based on the priorities. Alternatively, it may also be possible for the distribution unit D to transmit the response that has been received the earliest of the responses received from the plurality of sub controllers to the client terminal having transmitted, the request. Alternatively, it may also be possible for the distribution unit D to adopt majority responses from among the responses received from the plurality of sub controllers by using majority decision logic and to transmit one of the majority responses to the client terminal having transmitted the request.

Next, at step S84, the distribution unit determines that the sub controllers SC1 to SC3 that do not transmit the request attached with an identification number to the distribution unit D within a predetermined period of time after transmitting the request received from the client terminals T1 to T4 to the plurality of sub controllers SC1 to SC3 have an abnormality and transmits the identification numbers of the sub controllers SC1 to SC3 having been determined to have an abnormality to the mail address of the maintenance center M via the network by using an electronic mail. Further, the distribution unit 3 determines that the sub controllers SC1 to SC3 that do not transmit one response to the distribution unit D within a predetermined period of time after transmitting the response received from the plurality of servers S1 to S3 to the plurality of sub controllers SC1 to SC3 have an abnormality and transmits the identification numbers of the sub controllers SC1 to SC3 having been determined to have an abnormality to the mail address of the maintenance center 81 via the network N3 by using an electronic mail.

Next, at step S86, the client terminals T1 to T4 having transmitted the request, receive the response from the controller C and displays the received response on the display unit Td.

According to the system of the above-described embodiment, even if one sub controller fails, another sub controller operates, and therefore, it is possible to prevent the system 10 from being stopped.

Next, a third embodiment of the system that is disclosed in the present specification is explained below with reference to the drawings.

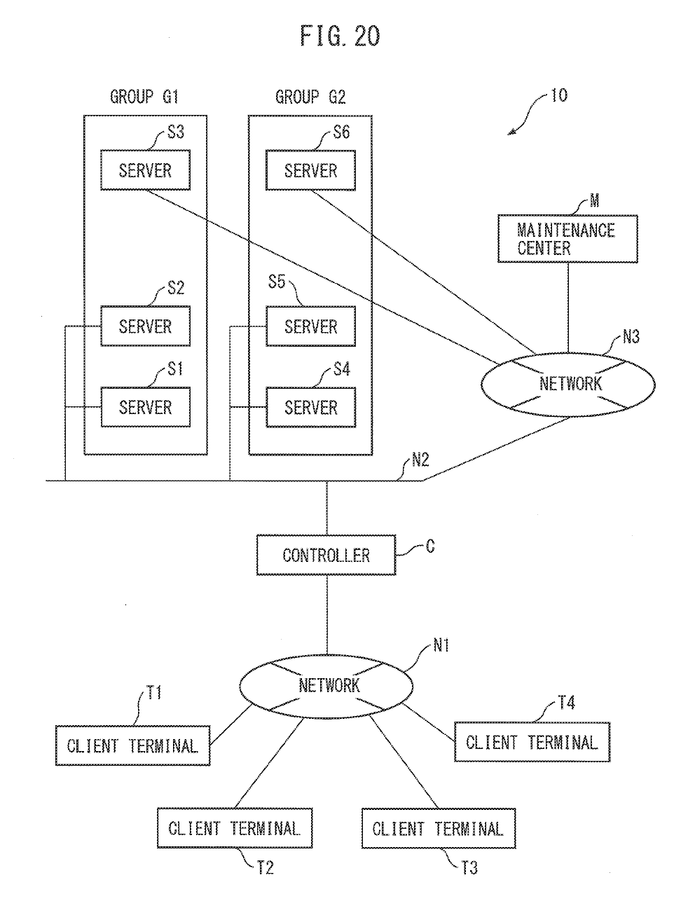

FIG. 20 is a system configuration diagram of the third embodiment that is disclosed in the present specification.

The system 10 of the present embodiment includes a group G1 consisting of the plurality of servers S1 to S3 and a group G2 consisting of a plurality of servers S4 to S6. The servers belonging to the same group have the same resources and perform the same operations by executing the same programs. Further, the servers belonging to the same group establish synchronization of the resources. On the other hand, the servers belonging to the different groups have different resources and may perform different kinds of processing by executing different programs.

The system 10 performs a transaction consisting of a plurality of successive requests received from the client terminal.

In the example illustrated in FIG. 20, the system 10 includes the two groups G1 and G2, but the system 10 may include three or more groups. Further, the system 10 may include only one group.

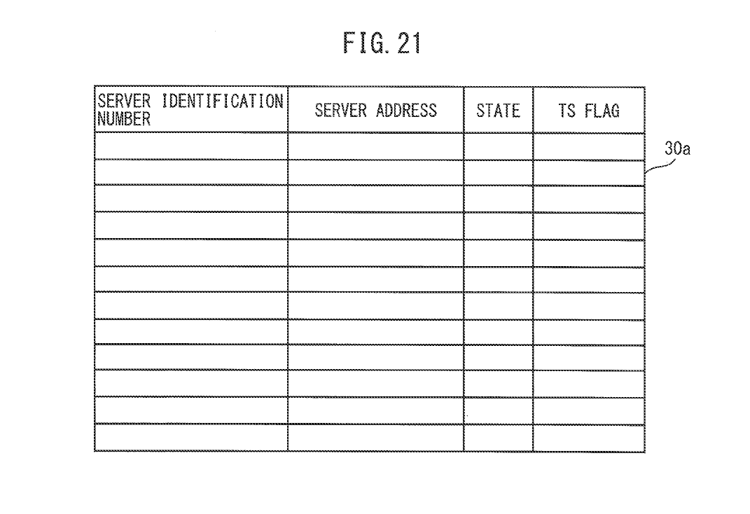

FIG. 21 is a diagram explaining the server list table 30a.

In the server list table 30a that is stored in the server list DB 30 possessed by the controller C, a TS flag recording the effectiveness of each server for a transaction, as well as a server identification number, a server address, and a state are recorded in association with one another.

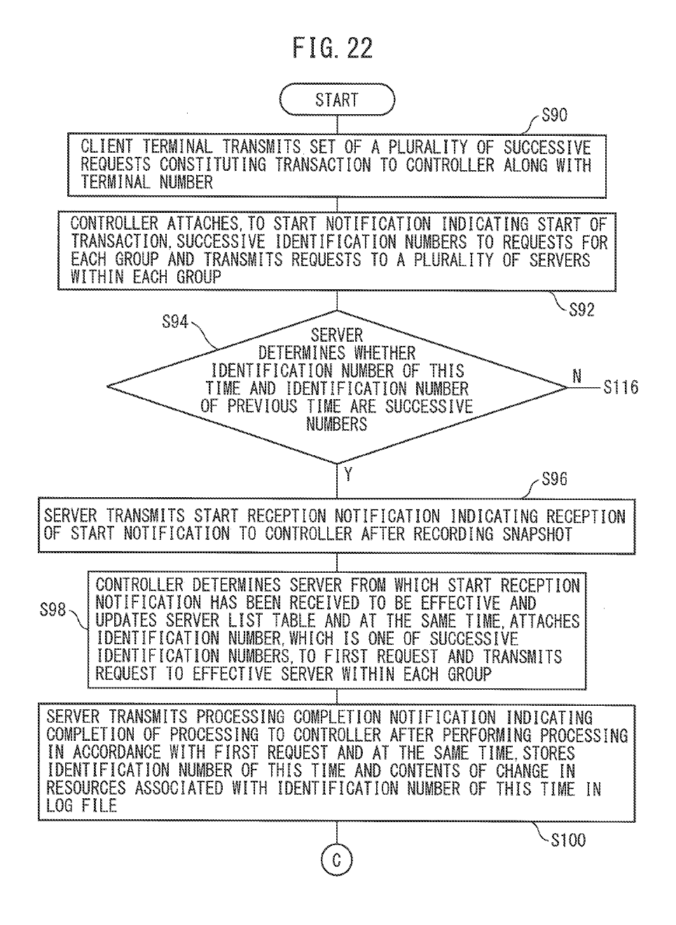

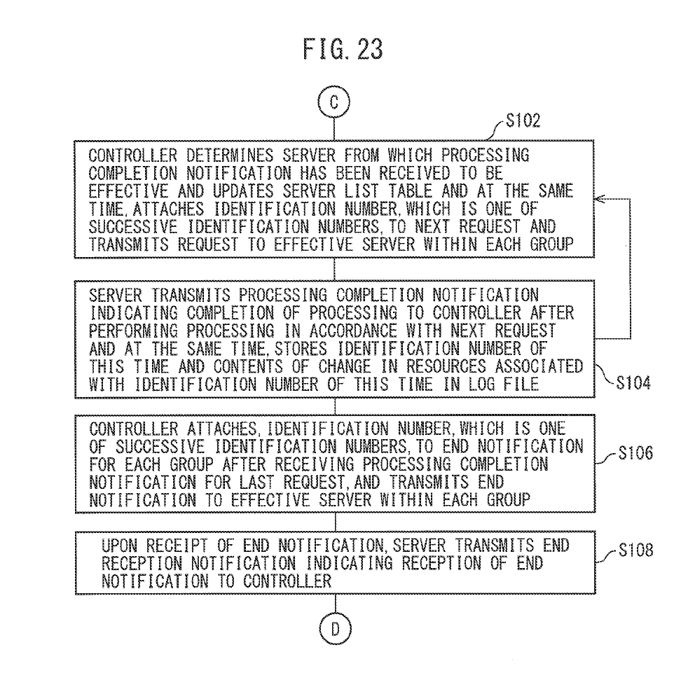

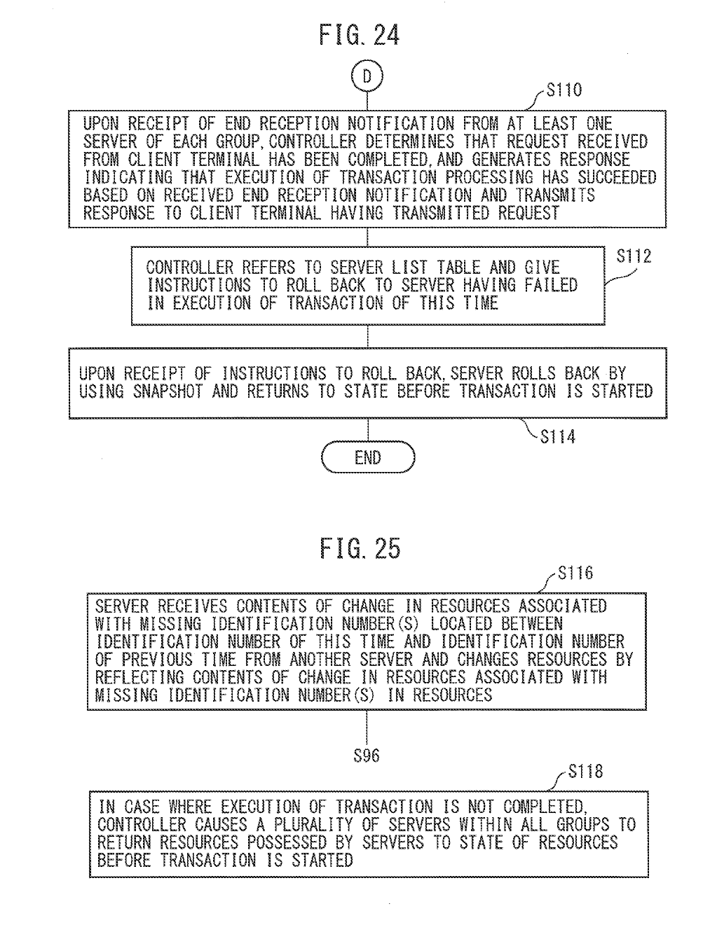

Next, an operation example of the system 10 of the present embodiment is explained below with reference to FIG. 22 to FIG. 25.

First, at step S90, one of the client terminals T1 to T4 transmits a set of a plurality of successive requests constituting a transaction to the controller C along with the terminal number after attaching information indicative of the start of the transaction or information indicative of the end of the transaction to the requests.

Next, at step S92, the controller C attaches successive identification numbers for each group G1, G2 to a start notification indicating the start of the transaction consisting of a set of requests and transmits the transaction to the plurality of servers S1 to S3 and S4 to S6 within each of the groups G1 and G2. As one method for securely performing the transaction, it may also be possible for the controller C to reject other requests until all of the processing of the set of requests constituting the received transaction is completed. Requests that are transmitted to each of the groups G1 and G2 are usually different between the group G1 and the group G2. On the other hand, the same requests are transmitted to the servers within the same group. When the transaction consisting of a plurality of successive requests is performed, successive identification numbers are attached to all the requests for each group, which are transmitted to each group. In this manner, in the present embodiment, the controller C attaches successive identification numbers to the requests received from the client terminal for each group and transmits the received requests to the plurality of servers within each of the groups G1 and G2. Further, it is also possible for the system 10 to perform processing in accordance with requests that do not constitute a transaction. Successive identification numbers are also attached to requests that do not constitute a transaction for each group, similar to each request constituting a transaction.

Next, at step S94, each of the servers S1 to S3 and S4 to S6 determines whether the identification number of this time attached to the received request and the identification number of the previous time attached to the request received the previous time are successive numbers. In the case where both the identification numbers are successive numbers, the processing proceeds to step S96. On the other hand, in the case where both the identification numbers are not successive numbers, the processing proceeds to step S116.

In the case where the processing has proceeded to step S96, each of the servers S1 to S3 and S4 to S6 transmits a start reception notification indicating that the start notification has been received to the controller C after recording a snapshot saving the current state. The snapshot is recorded in the storage unit Sb.

Next, at step S98, the controller C determines the server from which the start reception notification has been received to be effective. The controller C updates the server list table 30a and at the same time, attaches an identification number that is one of successive identification numbers to the first request for each group and transmits the request to the effective server within each of the groups G1 and G2 that is determined based on the transmission destination specified by the received request. In the TS flag of the server that has been determined to be effective, a flag indicating that the server is effective is recorded. On the other hand, in the TS flag of the server that is not determined to be effective, a flag indicating that the server is invalid is recorded. To the server that is not determined to be effective, the first request is not transmitted. The server that has been determined to be effective performs predetermined processing in accordance with the received request because the identification number of this time attached to the first request and the identification number of the previous time are successive numbers.

Next, at step S100, each of the servers S1 to S3 and S4 to S6 transmits a processing completion notification indicating that the processing is completed to the controller C after performing processing in accordance with the first request and at the same time, stores the identification number of this time and the contents of the change in the resources associated with the identification number of this time in the log file.

Next, at step S102, the controller C determines the server from which the processing completion notification has been received to be effective and updates the server list table 30a and at the same time, attaches an identification number that is one of successive identification numbers for each group to the next request of the plurality of successive requests and transmits the request to the effective server within each of the groups G1 and G2 that is determined based on the transmission destination specified by the received request. To the server that is not determined to be effective, the next request is not transmitted. The server that has been determined to be effective performs predetermined processing in accordance with the received request because the identification number of this time attached to the received request and the identification number of the previous time are successive numbers.

Next, at step S104, each of the servers S1 to S3 and S4 to S6 transmits the processing completion notification indicating that the processing is completed after performing processing in accordance with the next request of the plurality of successive requests and at the same time, stores the identification number of this time and the contents of the change in the resources associated with the identification number of this time in the log file. Step S102 to step S104 are repeated in accordance with the number of requests constituting a group.

Next, at step S106, after receiving the processing completion notification for the last request of the plurality of successive requests, the controller C attaches an identification number that is one of the successive identification numbers for each group to an end notification indicating that the transaction has ended and transmits the end notification to the effective server within each of the groups G1 and G2.

Next, at step S108, upon receipt of the end notification, each of the servers S1 to S3 and S4 to S6 transmits an end reception notification indicating that the end notification has been received to the controller C.

Next, at step S110, upon receipt of the end reception notification from at least one server within each of the groups G1 and G2 for the group G1 and the group G2, respectively, the controller C determines that the processing in accordance with the set of requests, i.e., the transaction received from the clients T1 to T4 has been completed. Then, the controller C generates a response indicating that the processing in accordance with the transaction has succeeded based on the end reception notification received from at least one server within each of the groups G1 and G2 for the group G1 and the group G2, respectively, and transmits the response to the client terminal having transmitted the requests. In the case where the end reception notification is not received from any server within the group in one of the group G1 and the group G2, the controller C transmits a response indicating that the processing in accordance with the transaction has failed to the client terminal having transmitted the requests.

Next, at step S112, the controller C refers to the server list table 30a and gives instruction to roll back to the server in the TS flag of which invalidity is recorded and which has failed in the execution of the transaction of this time.

Next, at step S114, the servers S1 to S3 and S4 to S6 given the instructions to roll back roll back by using the snapshot and return to the state before the transaction is started.

On the other hand, in the case where the identification numbers are not successive numbers at step S94, the processing proceeds to step S116.

In the case where the processing has proceeded to step S116, each of the servers S1 to S3 and S4 to S6 receives the contents of the change in the resources associated with a missing identification number(s) located between the identification number of this time and the identification number of the previous time from another server within the same group, changes the resources by reflecting the contents of the change in the resources associated with the missing identification number(s) in the resources, and establishes synchronization. Then, the processing proceeds to step S96.

As described above, in the present embodiment, in the case of having failed in execution of a transaction, each of the servers S1 to S3 and S4 to S6 rolls back and when receiving the next request, reflects the contents of the change in the resources associated with the missing identification number(s) in the resources and establishes synchronization of the resources. Further, as illustrated at step S118, in the where the execution of the transaction has not been completed, the controller C gives instructions to roll back to the plurality of servers S1 to S3 and S4 to S6 within all the groups so that the resources possessed by the servers are returned to the state of the resources before the execution of the transaction is started.

According to the above-described system of the present embodiment, even in the case where trouble has occurred in part of the servers, it is possible to execute a transaction consisting of a plurality of requests to change the resources across a plurality of resources without stopping the operation. Further, the system has properties of atomicity, consistency, and durability of the ACID properties that the transaction processing system is generally required to have. The property of isolation are not dealt with in the present invention and therefore not referred to.

In the present invention, the information processing system and the method thereof in the above-described embodiments can be changed appropriately as long as the embodiments do not deviate from the gist of the present invention. Further, it is possible to appropriately apply the component possessed by an embodiment to another embodiment.

For example, the information processing system that is disclosed in the present specification may use control devices at the entrance/exit gates arranged in a parking lot as the client terminals. In this case, the server may perform charging processing of parking fees and manage entrance and exit of vehicles. Further, it may also be possible to use a smart telephones, a tablet terminals, or a personal computers as the client terminals and to use the Internet as the network via which the controller and the client, terminals communicate with each other, and to install a plurality of servers that perform management of the mail-order sales of merchandise, management of the sale by subscription of airline tickets or tickets of concerts, etc., management of reservation of a parking lot, etc.

What is claimed is:

1. An information processing system in which a server having resources performs predetermined processing in accordance with a request received from a client terminal and generates a response and at the same time, changes the resources in correspondence to the contents of the processing and transmits the response to the client terminal, the information processing system comprising:
a controller connected with a client terminal(s) so as to be capable of performing communication; and
a plurality of the servers connected with the controller so as to be capable of performing communication, wherein
the controller:
attaches successive identification numbers to requests received from a client terminal and transmits the received requests to the plurality of servers; and
transmits a response generated based on one of the responses received from the plurality of servers or a plurality of responses received from the plurality of servers, to the client terminal having transmitted the request, and
each of the servers:
performs predetermined processing in accordance with the received request in the case where the identification number of this time attached to the received request and the identification number of the previous time attached to the request received the previous time are successive numbers, and generates a response and at the same time, changes the resources in correspondence to the contents of the processing, transmits the response to the controller, and stores the identification number of this time and the contents of the change in the resources associated with the identification number of this time; and
receives, in the case where the identification number of this time and the identification number of the previous time are not successive numbers, the contents of the change in the resources associated with a missing identification number(s) located between the identification number of this time and the identification number of the previous time from another of the servers and after changing the resources by reflecting the contents of the change in the resources associated with the missing identification number(s) in the resources, performs predetermined processing in accordance with the received request and creates a response and at the same time, changes the resources in correspondence to the contents of the processing, transmits the response to the controller, and stores the identification number of this time and the contents of the change in the resources associated with the identification number of this time.

2. The information processing system according to claim 1, wherein
the controller has:
a distribution unit; and
a plurality of sub controllers,
the distribution unit transmits:
a request received from a client terminal to the plurality of sub controllers;
one of the requests that are received from each of the sub controllers and to which identification numbers are attached to the plurality of servers;
responses received from the plurality of servers to the plurality of sub controllers; and
a response generated based on one of the responses received from the plurality of sub controllers or a plurality of responses received from the plurality of sub controllers, to the client terminal having transmitted the request, and
each of the sub controllers transmits:
requests received from the distribution unit to the distribution unit after attaching successive identification numbers to the requests; and
a response generated based on one of the responses received from the plurality of servers or a plurality of responses received from the plurality of servers, to the distribution unit.

3. The information processing system according to claim 2, wherein
the distribution unit:
determines that the sub controller that does not transmit a request to which an identification number is attached to the distribution unit within a predetermined period of time after transmitting the request received from a client terminal to the plurality of sub controllers has an abnormality;
determines that the sub controller that does not transmit a response to the distribution unit within a predetermined period of time after transmitting the responses received from the plurality of servers to the plurality of sub controllers has an abnormality; and
transmits information on the sub controller determined to have an abnormality to a predetermined address.

4. The in processing system according to claim 1, wherein
the controller determines that the server that does not transmit a response to the controller within a predetermined period of time after transmitting the received request to the plurality of servers has an abnormality, and transmits information on the server determined to have an abnormality to a predetermined address.

5. The information processing system according to claim 1, wherein
the controller transmits a response received the earliest of the responses received from the plurality of servers to a client terminal having transmitted the request.

6. The information processing system according to claim 1, wherein
the controller adopts majority responses by using majority decision logic for responses received from the plurality of servers and transmits one of the majority responses to a client terminal having transmitted the request.

7. The information processing system according to claim 1, wherein
the controller determines that, in the case where responses received from the plurality of servers do not agree with each other, the responses are invalid, and transmits a response indicating that the request cannot be executed to a client terminal having transmitted the request.

8. The information processing system according to claim 1, wherein
the resources are a database, a file, a memory, an information output unit, or a combination of these components.

9. The information processing system according to claim 1, comprising one or a plurality of groups consisting of the plurality of servers, each of the servers within the same group having the same resources and the servers belonging to different groups having different resources, wherein
the controller attaches successive identification numbers for each group to requests received from a client terminal and transmits the received requests to the plurality of servers within the group determined based on the transmission destinations specified, by the received requests, and
when executing a transaction consisting of a plurality of successive requests received from the client terminal, if the server arranged within each group has failed in transaction processing, the server returns the resources possessed by the server to the state of the resources before the execution of the transaction is started, changes the resources by reflecting the contents of the change in the resources associated with the missing identification number(s) in the resources when receiving a request of the next time, and establishes synchronization of the resources.

10. The information processing system according to claim 9, wherein
the controller:
does not transmit, in the case where a response indicating that the execution of a request has succeeded is not received, from the server to which the request, which is one of the requests constituting the transaction, is transmitted, the remaining requests constituting the transaction to the server;
determines that, in the case where a response indicating that the execution of a request has succeeded is not received from the server within the group, to which the request, which is one of the requests constituting the transaction, is transmitted, the execution of the transaction has failed;
gives instructions to return the resources possessed by the server to the state of the resources before the execution of the transaction is started to all the servers within all the groups; and
transmits a response indicating that the execution of the transaction has failed to the client terminal having transmitted the transaction.

11. An information processing method in which a server having resources performs predetermined processing in accordance with a request received from a client terminal and creates a response and at the same time, changes the resources in correspondence to the contents of the processing and transmits the response to the client terminal, the information processing method comprising the steps of:
by a controller connected with the client terminal(s) so as to be capable of performing communication, attaching successive identification numbers to the requests received from a client terminal and transmitting the received requests to the plurality of servers;
by each of the servers, performing predetermined processing in accordance with the received request in the case where the identification number of this time attached to the received request and the identification number of the previous time attached to the request received the previous time are successive numbers, and creating a response and at the same time, changing the resources in correspondence to the contents of the processing, transmitting the response to the controller, and storing the identification number of this time and the contents of the change in the resources associated with the identification number of this time;
by each of the servers, in the case where the identification number of this time and the identification number of the previous time are not successive numbers, receiving the contents of the change in the resources associated with a missing identification number(s) located between the identification number of this time and the identification number of the previous time from another of the servers and after changing the resources by reflecting the contents of the change in the resources associated with the missing identification number(s) in the resources, performing predetermined processing in accordance with the received request and creating a response and at the same time, changing the resources in correspondence to the contents of the processing, transmitting the response to the controller, and storing the identification number of this time and the contents of the change in the resources associated with the identification number of this time; and
by the controller, transmitting a response based on one of the responses received from the plurality of servers or a plurality of responses received from the plurality of servers, to the client terminal having transmitted the request.

12. The information processing method according to claim 11, wherein
the controller has:
a distribution unit; and
a plurality of sub controllers,
the step of, by the controller, attaching successive identification numbers to the requests received from the client terminal and transmitting the received requests to the plurality of servers has the steps of:
by the distribution unit, transmitting a request received from the client terminal to the plurality of sub controllers;
by each of the sub controller, attaching successive identification numbers to the requests received from the distribution unit and transmitting the received requests to the distribution unit; and
by the distribution unit,
transmitting one of the requests received from the sub controller and to which identification numbers are attached to the plurality of servers, and
the step of, by the controller, transmitting a response generated based on one of the responses received from the plurality of servers or a plurality of responses received from the plurality of servers, to the client terminal having transmitted the request has the steps of:
by the distribution unit, transmitting a responses received from the plurality of servers to the plurality of sub controllers;
by each of the sub controllers, transmitting a response generated based on one of the responses received from the plurality of servers or a plurality of responses received from the plurality of servers, to the distribution unit; and
by the distribution unit, transmitting a response generated based on one of the responses received from the plurality of sub controllers or a plurality of responses received from the plurality of sub controllers, to the client terminal having transmitted the request.

13. The information processing method according to claim 11, wherein
in the step of, by the controller, transmitting one of the responses received from the plurality of servers or a plurality of the responses received from the plurality of servers, to the client terminal having transmitted the request, the controller transmits the response received the earliest of the responses received from the plurality of servers to the client terminal having transmitted the request.

14. The information processing method according to claim 11, wherein
in the step of, by the controller, transmitting one of the responses received from the plurality of servers or a plurality of the responses received from the plurality of servers, to the client terminal having transmitted the request, the controller adopts majority responses by using majority decision logic for the responses received from the plurality of servers and transmits one of the majority responses to the client terminal having transmitted the request.

15. An information processing system in which a server having resources performs predetermined processing in accordance with a request received from a client terminal, changes the resources in correspondence to the contents of the processing, and transmits the result (s) of processing of one or a plurality of requests to the client terminal, the information processing system comprising:
a plurality of servers each having resources; and
a controller capable of communicating with both the plurality of servers and the client terminal(s), wherein
the controller has a first unit configured to generate successive identifiers in correspondence to the order of reception for the requests received, from the client terminal, to attach the identifier to each request, and to transmit the requests to the server, and
the server has:
a second unit configured to determine whether or not there exists a request (s) not received yet between the request received the previous time and the request received this time by using the successiveness of the identifiers attached to the requests received from the controller; and
a third unit configured to make an inquiry about information on the contents of a change (s) in the resources that should be changed in correspondence to the request (s) not received yet when the second unit determines that the request (s) that is not received yet exists.

16. A controller of the information processing system according to claim 15, the controller comprising:
an identification number generation unit configured to generate successive identification numbers; and
a memory for recording information about the generated identification numbers, wherein
the controller refers to the memory recording the identification numbers for requests received from a client terminal, reads information on the identification number generated for the request received the previous time, generates a successive identification number by using the identification number generation unit configured to generate a successive identification number for the request received this time, attaches the identification number to the received request, and transmits the request to the plurality of servers, and
the controller generates a response based on one or a plurality of responses received from the plurality of servers and transmits the response to the client terminal having transmitted the request.

17. A server of the information processing system according to claim 15 having the controller according to claim 16, wherein
the server:
performs, in the case where the identification number of this time attached to the received request and the identification number of the previous time attached to the request received the previous time are successive numbers, predetermined processing in accordance with the request and stores the contents of a change made to the resources in correspondence to the contents of the processing in association with the identification number; and
receives, in the case where the identification number of this time attached to the received request and the identification number of the previous time attached to the request received the previous time are not successive numbers, the contents of a change (s) in the resources associated with a missing identification number(s) located between the identification number of this time and the identification number of the previous time from another of the servers and after changing the resources by reflecting the contents of the change associated with the missing identification number(s) in the resources, performs predetermined processing in accordance with the request and stores the contents of the change made to the resources in correspondence to the contents of the processing in association with the identification number.
